(19) United States
(12) Patent Application Publication
(10) Pub. No.: US 2015/0214524 A1
(43) Pub. Date: Jul. 30, 2015

(54) BATTERY MODULE

(71) Applicant: PANASONIC INTELLECTUAL PROPERTY MANAGEMENT CO., LTD., Osaka (JP)

(72) Inventors: Hiroshi Takasaki, Osaka (JP); Yukinori Hamafuku, Hyogo (JP)

(21) Appl. No.: 14/425,319

(22) PCT Filed: Sep. 3, 2013
(86) PCT No.: PCT/JP2013/005200

§ 371 Date: Mar. 2, 2015

(30) Foreign Application Priority Data
Sep. 5, 2012 (JP) 2012-194899

(51) Int. Cl. H01M 2/12; H01M 2/20; H01M 2/10

(52) U.S. Cl. CPC H01M 2/12; H01M 2/1077; H01M 2/20; H01M 2220/20

(57) ABSTRACT

A battery module includes a plurality of battery blocks connected in series. Each battery block includes a plurality of batteries connected in parallel, and each battery includes a release portion through which a gas generated in the battery is released. Each battery block includes a holder in which the batteries are housed with the release portions oriented in the same direction, a bus bar provided over the holder and connecting in parallel electrodes of the batteries, a lid provided over the bus bar and defining therebetween an exhaust chamber through which the gas released from the release portions is released outside the battery block. The lids of at least two of the battery blocks are physically connected to each other. Each lid is made of aluminum or a material having an ionization tendency greater than that of aluminum, and the bus bar is made of copper.

### TECHNICAL FIELD

The present disclosure relates to a battery module including a plurality of battery blocks which are connected to one another and each include a plurality of batteries.

### BACKGROUND ART

Battery packs each including a plurality of batteries housed in a case so as to output a predetermined voltage and have a predetermined capacity are widely used as power sources for various equipment and vehicles. In particular, a technique by which general-purpose batteries are connected in parallel and/or in series to form battery blocks each outputting a predetermined voltage and having a predetermined capacity and two or more of the battery blocks are connected to form a battery module has been in practical use. Combining such battery modules in various manners enables application of the battery modules in a wide variety of uses.

On the other hand, as the performance of batteries forming battery modules has been enhanced, it has become more and more important to increase the safety of batteries modules as groups of batteries as well as the safety of batteries themselves. In particular, in a situation where a gas is generated by heat due to, for example, an internal short circuit in a battery and a safety valve is actuated to release the gas having high temperature to the outside of the battery, if adjacent normal batteries are exposed to this gas having high temperature, the normal batteries might also be affected and sequentially suffer degradation.

To address this problem, Patent Document 1 describes a battery module including a casing housing a plurality of batteries, wherein the casing is partitioned by a circuit board disposed in contact with the batteries into a housing space where the batteries are housed and an exhaust chamber through which a gas released from the batteries is released outside the casing. This exhaust mechanism prevents the gas released from a battery in an abnormal state into the exhaust chamber from re-entering the housing space and releases the gas to the outside of the casing. It is thus possible to prevent the normal batteries from being exposed to the high-temperature gas.

### CITATION LIST

### Patent Document

PATENT DOCUMENT 1: Japanese Patent No. 4749513

### SUMMARY OF THE INVENTION

### Technical Problem

The battery module having the exhaust mechanism of Patent Document 1 is not hermetically sealed. Therefore, for example, when a battery pack including the battery modules is installed in a vehicle such as an automobile and the vehicle runs on a flooded road, water such as seawater may enter the battery pack.

However, very little consideration has conventionally been given to securing of the safety of a battery pack in case of entry of water such as seawater into the battery pack.

It is therefore a main object of the present disclosure to provide a battery pack capable of securing the safety even when water such as seawater has entered the battery pack.

### Solution to the Problem

A battery module of the present disclosure includes a plurality of battery blocks connected in series, wherein each battery block includes a plurality of batteries connected in parallel, each battery includes a release portion through which a gas generated in the battery is released, each battery block further includes a holder in which the batteries are housed with the release portions oriented in an identical direction, a bus bar provided over the holder and connecting in parallel electrodes of the batteries located toward the release portions, and a lid provided over the bus bar and defining between the bus bar and the lid an exhaust chamber through which the gas released from at least one of the release portions is released outside the battery block, the lids of at least two of the battery blocks are physically connected to each other, the lid of each battery block is made of aluminum or a material having an ionization tendency greater than that of aluminum, and the bus bar is made of copper.

### Advantages of the Invention

According to the present disclosure, the safety of a battery pack can be secured even if water such as seawater has entered the battery pack.

### BRIEF DESCRIPTION OF THE DRAWINGS

FIG. 1 is a cross-sectional view illustrating a configuration of a battery for use in a battery block according to an embodiment of the present disclosure.

FIG. 2 is a perspective exploded view illustrating a configuration of a battery block forming a battery module according to an embodiment of the present disclosure.

FIG. 3 is a perspective view of the battery block of FIG. 2, in an assembled state.

FIG. 4 is a cross-sectional view of the battery block of FIG. 3.

FIG. 5 schematically illustrates a phenomenon which occurs when seawater or the like has entered a battery module.

FIGS. 6A and 6B are equivalent circuit diagrams of the state illustrated in FIG. 5.

FIG. 7 illustrates a state where depositions on positive electrode bus bars of stacked battery blocks have reached the inner faces of lids.

FIGS. 8A and 8B are equivalent circuit diagrams of the state illustrated in FIG. 7.

FIG. 9 schematically illustrates interruption of a short-circuit path formed by dissolution of a lid.

FIG. 10 schematically illustrates interruption of a short-circuit path formed by dissolution of lids.

FIG. 11 is a perspective view illustrating an example of series connection between battery blocks.

### DESCRIPTION OF EMBODIMENTS

Embodiments of the present disclosure will be described hereinafter in detail with reference to the drawings. The present disclosure is not limited to the following embodiments. Various changes and modifications may be made without departing from the scope of the present disclosure, and the following embodiments may be combined as necessary.

A battery module according to the present disclosure includes a plurality of battery blocks which are connected to one another and each include a plurality of batteries. The batteries forming each battery block are connected in parallel, and the battery blocks forming the battery module are connected in series.

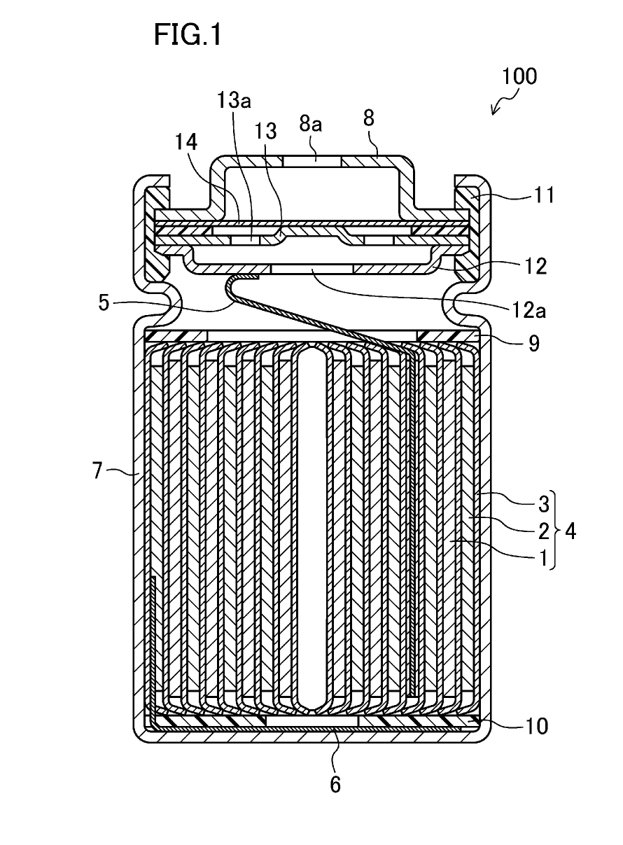

FIG. 1 is a cross-sectional view illustrating a configuration of one of a plurality of batteries 100 for use in each battery block according to an embodiment of the present disclosure. As the battery 100 for use in the battery block of the present disclosure, a cylindrical lithium ion secondary battery as illustrated in FIG. 1 can be employed.

The configuration of the battery 100 is specifically described below with reference to FIG. 1. Note that each battery 100 for use in the battery block of the present disclosure is not limited to the embodiments described below.

As illustrated in FIG. 1, an electrode group 4 in which a positive electrode 1 and a negative electrode 2 are wound with a separator 3 interposed therebetween is housed in a battery case 7 together with a non-aqueous electrolyte (not shown). Insulating plates 9 and 10 are respectively placed on the top and bottom of the electrode group 4. The positive electrode 1 is joined to a filter 12 with a positive electrode lead 5. The negative electrode 2 is joined to the bottom of the battery case 7 also serving as a negative electrode terminal, with a negative electrode lead 6.

The filter 12 is connected to an inner cap 13 which has a projection joined to a valve 14. The valve 14 is connected to a sealing plate 8 also serving as a positive electrode terminal. The sealing plate 8 has, in a projection thereof, a release portion 8a through which a gas generated in the battery is released. The sealing plate 8, the valve 14, the inner cap 13, and the filter 12 connected together seal an opening of the battery case 7 with a gasket 11.

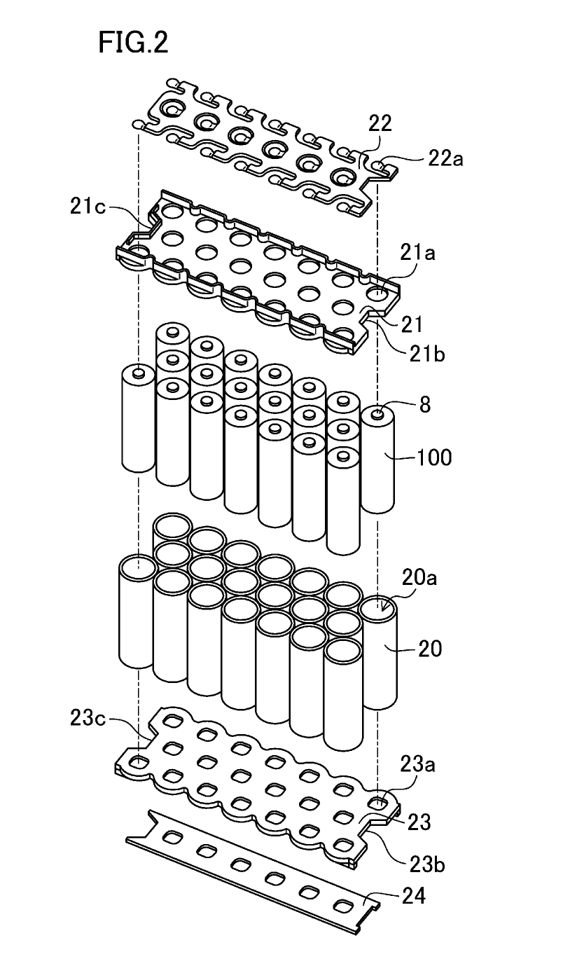

FIG. 2 is a perspective exploded view illustrating a configuration of the battery block forming the battery module according this embodiment.

As illustrated in FIG. 2, the plurality of batteries 100 are arranged such that their positive electrode terminals 8 (their release portions 8a) are oriented in the same direction. Each battery 100 is housed in a corresponding one of cylindrical hollow housing portions 20a of a holder 20.

A positive electrode bus bar 22 is provided above the holder 20 with an insulating spacer 21 interposed therebetween. The positive electrode bus bar 22 has connection terminals 22a formed at locations corresponding to the positive electrode terminals 8 of the batteries 100. The positive electrode terminals 8 of the batteries 100 are connected to the corresponding connection terminals 22a through corresponding openings 21a formed in the spacer 21. Thus, the positive electrode terminals 8 of the batteries 100 are electrically connected in parallel to one another by the positive electrode bus bar 22.

A negative electrode bus bar 24 is provided toward the negative electrode terminals (the bottoms of the battery cases 7) of the batteries 100 with an insulating spacer 23 interposed therebetween. The spacer 23 has openings 23a formed at locations corresponding to the negative electrode terminals of the batteries 100. The negative electrode terminals of the batteries 100 are connected to the negative electrode bus bar 24 through the openings 23a. Thus, the negative electrode terminals of the batteries 100 are electrically connected in parallel to one another by the negative electrode bus bar 24.

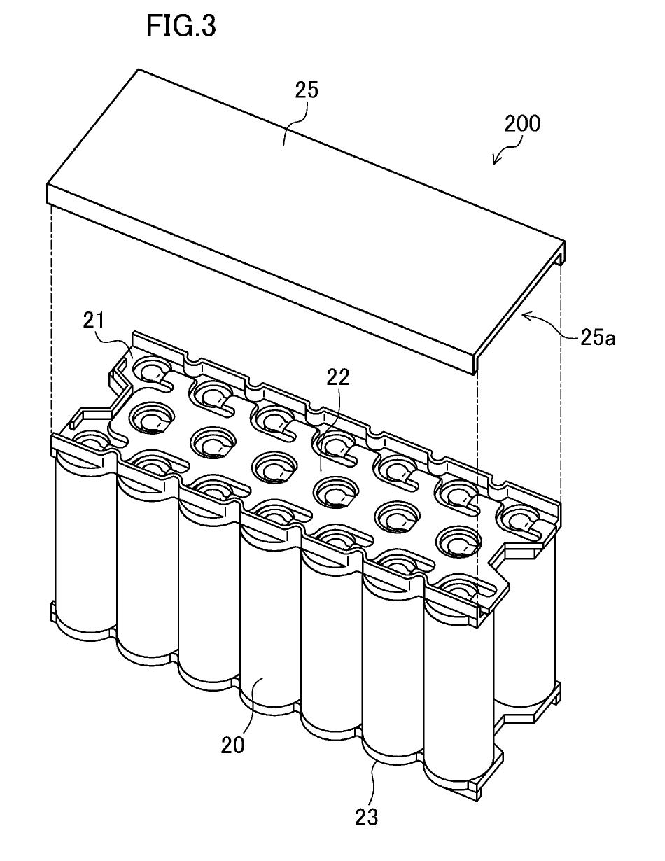

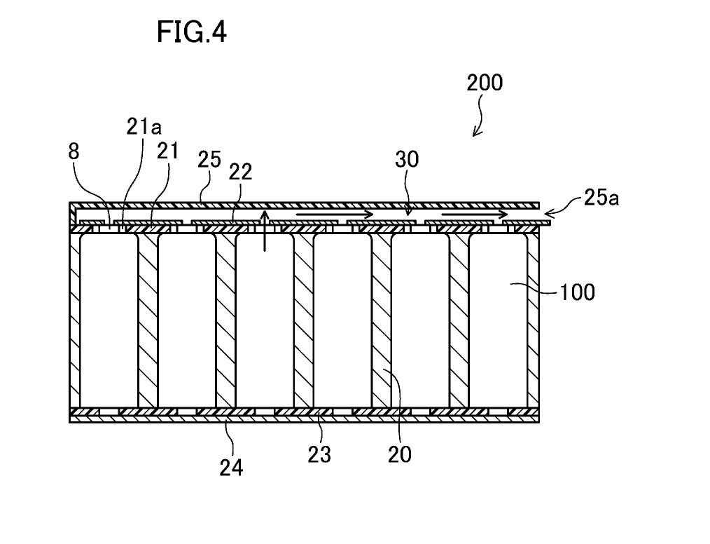

FIG. 3 is a perspective view of the battery block of FIG. 2, in an assembled state. FIG. 4 is a cross-sectional view of the battery block of FIG. 3.

As illustrated in FIG. 3, the battery block 200 of this embodiment further includes a lid 25 provided over the positive electrode bus bar 22. As illustrated in FIG. 4, the lid 25 and the positive electrode bus bar 22 define therebetween an exhaust chamber 30 through which a gas released from the release portion 8a of at least one of the batteries 100 is released outside the battery block 200. As indicated by the arrows in FIG. 4, the gas released from the release portion 8a into the exhaust chamber 30 passes through the exhaust chamber 30, and is released outside the battery block 200 through an exhaust port 25a formed in an end portion of the lid 25.

The lid 25 has the exhaust port 25a to release a gas released into the exhaust chamber 30 to the outside of the battery block 200. Accordingly, when water having electrical conductivity such as seawater (hereinafter, collectively referred to as the “seawater”) has entered a battery module including a plurality of the battery blocks 200, the seawater may also enter the battery blocks 200.

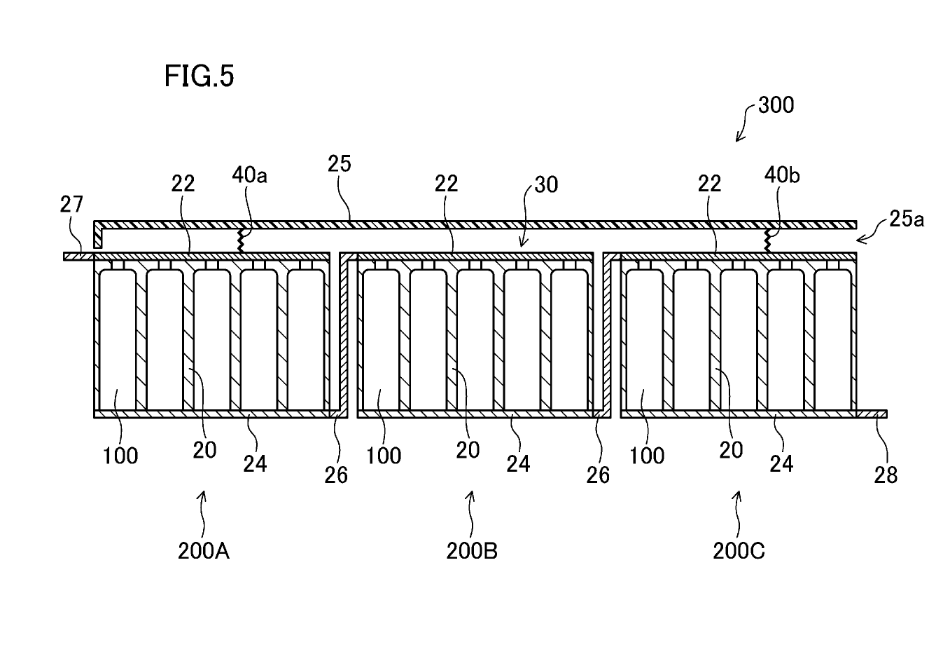

FIG. 5 schematically illustrates a phenomenon which occurs when seawater has entered a battery module 300. The battery module 300 illustrated in FIG. 5 includes three battery blocks 200A, 200B, and 200C which are connected in series. Specifically, two adjacent ones of these battery blocks are connected in series by a connection bar 26 connecting the negative electrode bus bar 24 of one of the adjacent blocks to the positive electrode bus bar 22 of the other one of the adjacent blocks. Further, the battery module 300 has a positive electrode terminal 27 extending from the positive electrode bus bar 22 of the battery block 200A, and a negative electrode terminal 28 extending from the negative electrode bus bar 24 of the battery block 200C.

Here, the lids 25 of the battery blocks 200A, 200B, and 200C are formed as a common lid. Specifically, the lids 25 of the battery blocks 200A, 200B, and 200C are physically connected together. In other words, when each lid 25 is made of a metal (e.g., iron), the lids 25 of the battery blocks 200A, 200B, and 200C are in electrical continuity. Note that the insulating spacer 21 illustrated in FIG. 4 is omitted from FIG. 5, and the lids 25 are electrically insulated from the positive electrode bus bars 22.

Here, when seawater has entered the battery block 200 and has covered the positive electrode bus bar 22 which is made of copper for example, the copper of the positive electrode bus bar 22 dissolves in the seawater, and then, is deposited on the positive electrode bus bar 22.

It is conceivable that when the deposition on the positive electrode bus bar 22 increases, the deposition reaches the ceiling of the exhaust chamber 30, i.e., the inner face of the lid 25.

FIG. 5 illustrates a state where depositions 40a and 40b on the positive electrode bus bars 22 of the battery blocks 200A and 200C have reached the inner face of the common lid 25.

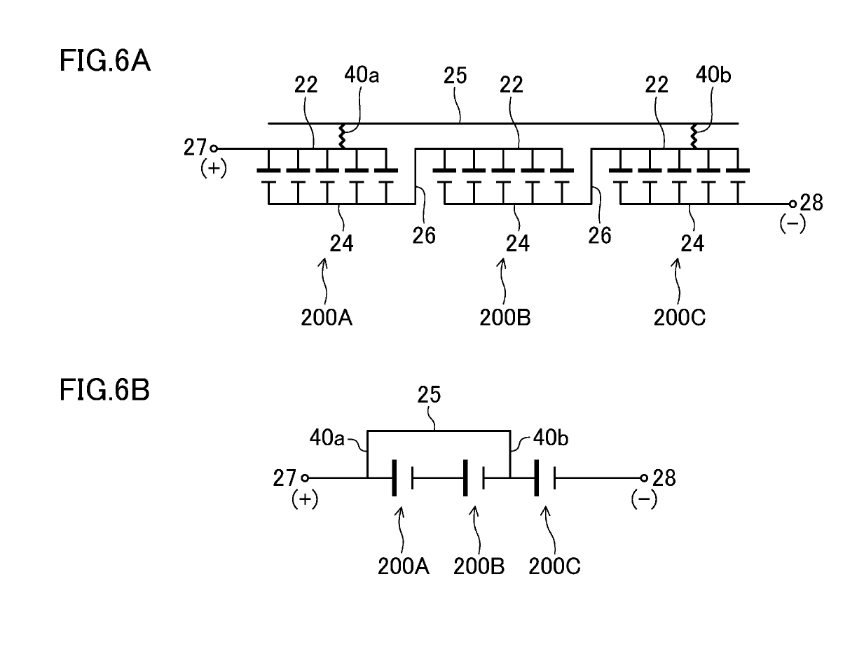

FIGS. 6A and 6B each represent this state in the form of an equivalent circuit diagram. Specifically, FIG. 6A is the equivalent circuit diagram according to the actual arrangement, and FIG. 6B is the equivalent circuit diagram in units of the battery blocks.

As illustrated in FIG. 6A, the positive electrode bus bar 22 of the battery block 200A and the positive electrode bus bar 22 of the battery block 200C are connected to each other by the lid 25 and the depositions 40a and 40b. That is, as illustrated in FIG. 6B, the positive electrode and the negative electrode of the battery blocks 200A and 200B connected in series are short-circuited by the lid 25 and the depositions 40a and 40b.

If the battery module continues to be in this state, a short-circuit current continuously passes and causes the batteries 100 of the battery blocks 200A and 200B to generate heat, thereby incurring the risk of combustion of the batteries 100.

Since the lids 25 of the battery blocks 200A, 200B, and 200C of the battery module 300 of FIG. 5 are formed as the common lid 25, the battery module may enter a short-circuit mode as described above. That is, a battery module including a plurality of battery blocks connected in series may enter the short-circuit mode if the lids of the battery blocks are physically connected together.

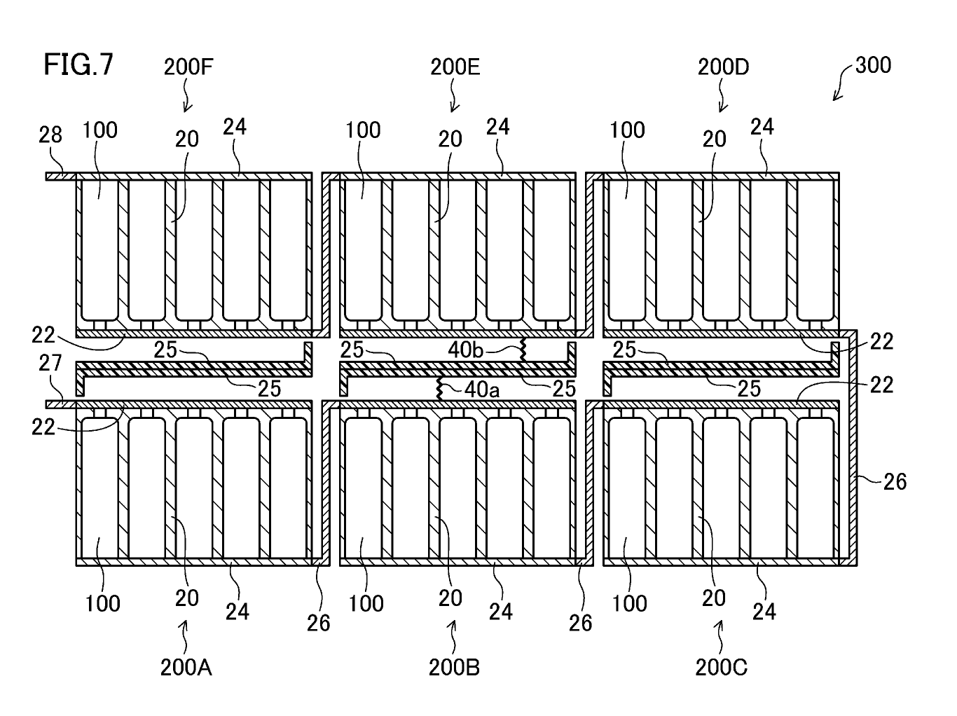

FIG. 7 illustrates another configuration of the battery module 300 which may conceivably enter the short-circuit mode as described above.

As illustrated in FIG. 7, six battery blocks 200A-200F are connected in series by connection bars 26. Specifically, on a group of three battery blocks 200A-200C, a group of three battery blocks 200D-200F is stacked such that the lids 25 of each pair of the stacked battery blocks are in contact with each other at the faces opposite to the batteries of the corresponding battery block. That is, the lids 25 of the battery blocks 200A and 200F are physically connected to each other, i.e., are in electrical continuity. Likewise, the lids 25 of the battery blocks 200B and 200E are physically connected to each other, i.e., are in electrical continuity, and the lids 25 of the battery blocks 200C and 200D are physically connected to each other, i.e., are in electrical continuity. Note that the insulating spacer 21 illustrated in FIG. 4 is omitted from FIG. 7, and the lids 25 of the battery blocks 200A-200F are each electrically insulated from the corresponding positive electrode bus bar 22.

FIG. 7 illustrates a state where depositions 40a and 40b on the positive electrode bus bars 22 of the stacked battery blocks 200B and 200E have reached the inner faces of the corresponding lids 25.

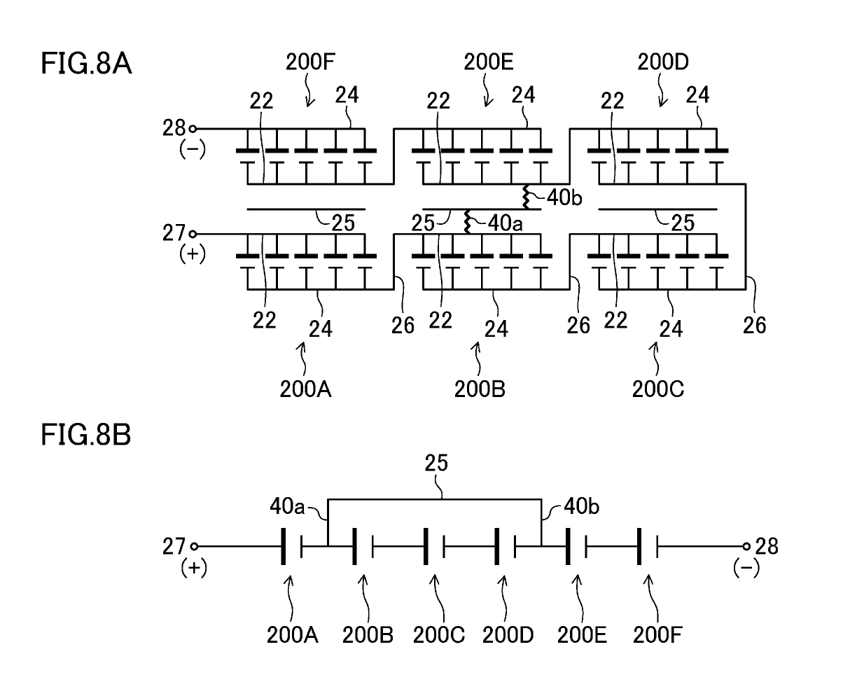

FIGS. 8A and 8B each represent this state in the form of an equivalent circuit diagram. Specifically, FIG. 8A is the equivalent circuit diagram according to the actual arrangement, and FIG. 8B is the equivalent circuit diagram in units of the battery blocks.

As illustrated in FIG. 8A, the positive electrode bus bar 22 of the battery block 200B and the positive electrode bus bar 22 of the battery block 200E are connected to each other by the corresponding lids 25 and 25 that are in contact with each other and the depositions 40a and 40b. That is, as illustrated in FIG. 8B, the positive electrode and the negative electrode of the battery blocks 200B-200D connected in series are short-circuited by the lids 25, 25 in contact and the depositions 40a, 40b.

Although the positive electrode and the negative electrode of the battery blocks connected in series may be short-circuited by the depositions 40a and 40b and the lid(s) 25 to cause combustion of the batteries in the battery blocks, no consideration has conventionally been given to precautions against the combustion.

In view of this problem, the present disclosure aims to provide a battery module capable of preventing a short circuit which may occur in a battery block due to an increase in a deposition in case of entry of seawater into the battery block.

Seawater covering the positive electrode bus bar 22 causes deposition of copper on the positive electrode bus bar 22. The deposition having increased to reach the lid 25 causes the lid 25 to form a short-circuit path. Therefore, interruption of the short-circuit path that the lid 25 forms prevents a short circuit in the battery block.

The inventors of the present disclosure became aware that a lid 25 made of aluminum causes interruption of the short-circuit path that the lid 25 forms when the lid 25 is covered with seawater because aluminum is electrolyzed and dissolves in seawater in accordance with the following reaction formula.

Al→Al³⁺+3e⁻ (1)

At this time, electrons are attracted to the copper of the positive electrode bus bar 22, thereby producing hydrogen in accordance with the following formula.

2H⁺+2e⁻→H₂ (2)

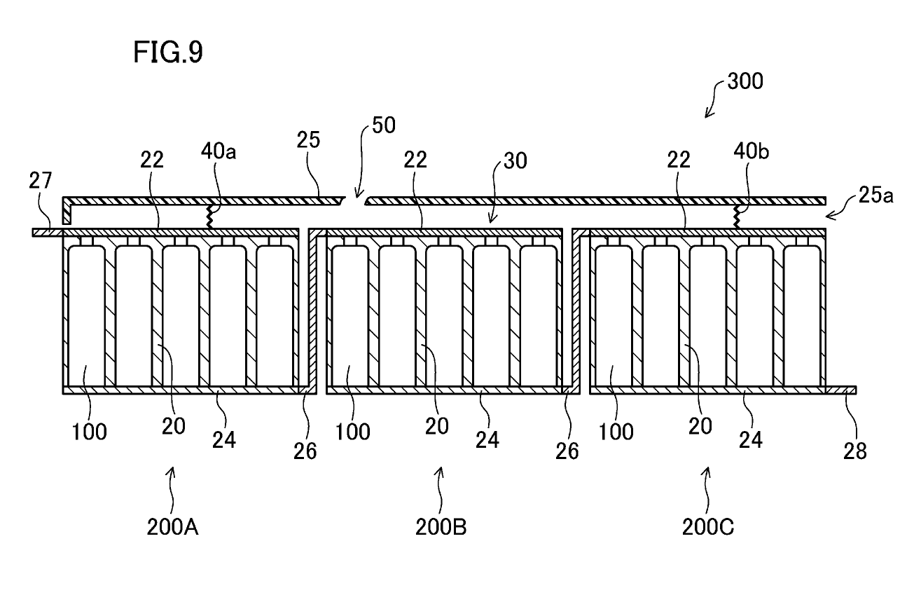

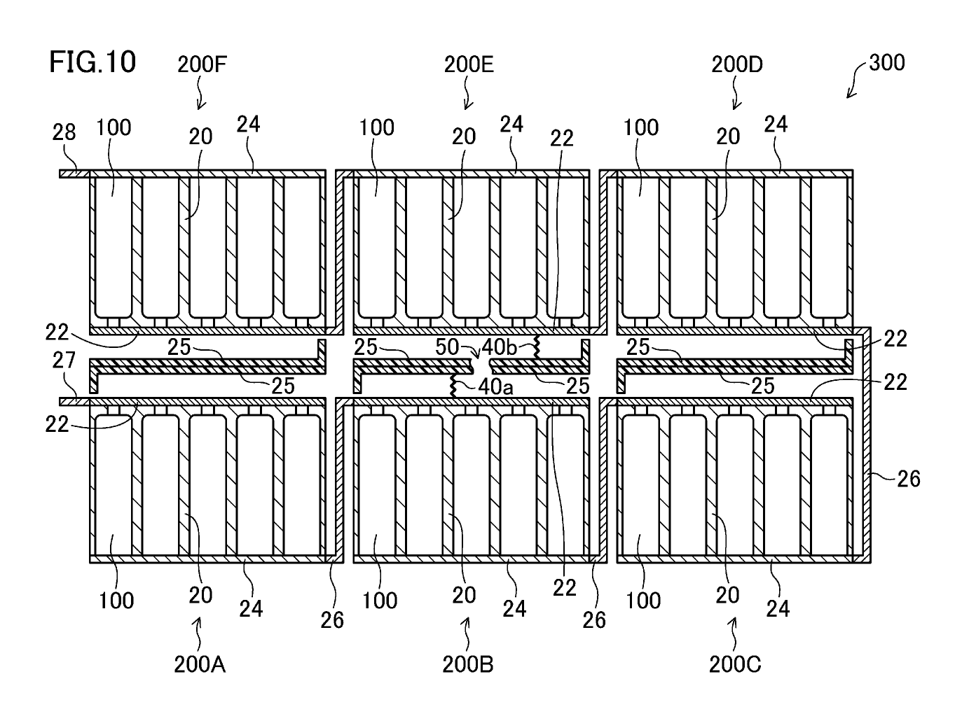

FIGS. 9 and 10 schematically illustrate interruption of the short-circuit path caused by dissolution of the lid(s) 25. FIG. 9 corresponds to the battery module 300 having the configuration illustrated in FIG. 5, and FIG. 10 corresponds to the battery module 300 having the configuration illustrated in FIG. 7.

As illustrated in FIG. 9, aluminum forming the lid 25 dissolves, and a hole 50 is formed in a portion of the lid 25. Consequently, the continuity of the lid 25 between the depositions 40a and 40b is interrupted, thereby enabling prevention of a short circuit of the battery blocks 200A and 200B.

Likewise, as illustrated in FIG. 10, a hole 50 is formed in a portion of the lids 25 and 25 of the staked battery blocks 200B and 200E. Consequently, the continuity of the lids 25 and 25 between the depositions 40a and 40b is interrupted, thereby enabling prevention of a short circuit of the battery blocks 200B-200D.

Note that although FIGS. 9 and 10 illustrate, for the sake of explanation, that the hole 50 is formed in a portion of the lid(s) 25, the lid(s) 25 actually dissolves almost uniformly. Therefore, irrespective of the positions of the depositions 40a and 40b, the advantages offered by the interruption of the short-circuit path that the lid(s) 25 forms can be obtained.

The lid 25, which defines the exhaust chamber 30, needs to have a thickness which maintains a certain mechanical strength. It is therefore necessary to take into account how long it takes for a piece of aluminum having a predetermined thickness to dissolve in seawater.

On the other hand, when the lid 25 is made of aluminum, aluminum is electrolyzed and the reactions represented by Formulas (1) and (2) above progress, and accordingly, electrical discharge of the batteries 100 is promoted. Consequently, even if the short-circuit path that the lid 25 forms remains for a while without being interrupted, no large short-circuit current flows. It is therefore possible to avoid an unsafe mode which can lead to combustion of the batteries.

In order to examine the advantages offered by the interruption of the short-circuit path that the lid 25 of aluminum forms, the inventors conducted the following experiment.

Battery blocks 200 which each included twenty cylindrical lithium ion secondary batteries having a capacity of 2.9 mAh and connected in parallel were prepared. Battery modules 300 each including six battery blocks 200 connected in series in such an array as illustrated in FIG. 7 were prepared.

Each positive electrode bus bar 22 was made of a copper plate having a thickness of 1 mm Each lid 25 was made of an aluminum plate having a thickness of 2 mm. The spacing between each positive electrode bus bar 22 and the corresponding lid 25 (i.e., the height of each exhaust chamber 30) was set to 6.5 mm. For purposes of comparison, a battery module 300 including lids 25 each made of an iron plate having a thickness of 0.5 mm was also prepared.

The battery modules 300 were soaked and left in water containing 5% of salt. In the battery module 300 including the lids 25 of iron, an increase in the battery temperature was detected after a lapse of about 1-3 hours, and combustion of the batteries was observed within about 30 minutes.

On the other hand, in the battery module 300 including the lids 25 of aluminum, no increase in the battery temperature was detected, and the aluminum began to dissolve to form a hole in a portion of the lids 25 after a lapse of about 10 minutes. In none of the batteries, combustion occurred during the experiment.

The results of the experiment show that the lid 25 made of aluminum can advantageously interrupt the short-circuit path that the lid 25 forms, and can prevent a short circuit of the battery block in case of entry of seawater into the battery pack.

The lid 25 may be made of, apart from aluminum, a material having an ionization tendency greater than that of aluminum (e.g., magnesium). The lid 25 made of such a material can also provide similar advantages of interruption.

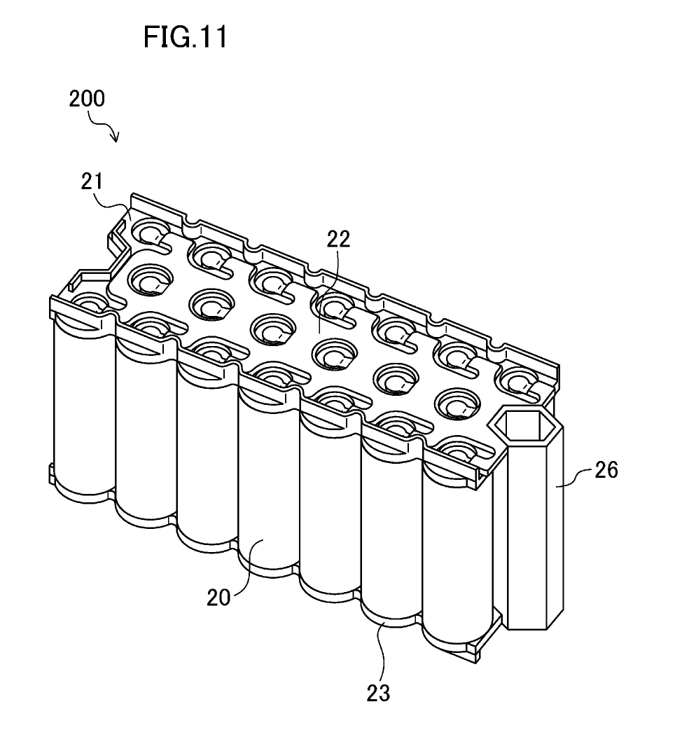

FIG. 11 is a perspective view illustrating an example of series connection between battery blocks 200.

As illustrated in FIG. 2, the insulating spacers 21 and 23 respectively provided on the top and the bottom of the holder 20 have notches 21b, 21c, 23b, and 23c formed in both ends thereof. As illustrated in FIG. 11, a side portion of the connection bar 26 is fitted into the notch 21b formed one of in the ends of the spacer 21 and the notch 23b formed in one of the ends of the spacer 23. At this time, the lower end of the connection bar 26 is in contact with the negative electrode bus bar 24, and the upper end of the connection bar 26 is out of contact with the positive electrode bus bar 22. The connection bar 26 in this state is fitted into the notch 21c of the spacer 21 and the notch 23c of the spacer 23 of an adjacent battery block. At this time, the upper end of the connection bar 26 is in contact with the positive electrode bus bar 22 of the adjacent battery block, and the lower end of the connection bar 26 is out of contact with the negative electrode bus bar 24 of the adjacent battery block. Thus, in the battery blocks adjacent to each other, the connection bar 26 can connect in series the negative electrode bus bar of one of the battery blocks to the positive electrode bus bar of the other battery block.

### INDUSTRIAL APPLICABILITY

The present disclosure is useful as power sources for driving an automobile, an electric motor cycle, and electric play equipment, for example.

### DESCRIPTION OF REFERENCE CHARACTERS

1 Positive Electrode

2 Negative Electrode

3 Separator

4 Electrode Group

5 Positive Electrode Lead

6 Negative Electrode Lead

7 Battery Case

8 Positive Electrode Terminal (Sealing Plate)

8a Release Portion

9, 10 Insulating Plate

11 Gasket

12 Filter

13 Inner Cap

14 Valve

20 Holder

20a Housing Portion

21 Spacer

21a Opening

21b, 21c Notch

22 Positive Electrode Bus Bar

22a Connection Terminal

23 Spacer

23a Opening

23b, 23c Notch

24 Negative Electrode Bus Bar

25 Lid

25a Exhaust Port

26 Connection Bar

27 Positive Electrode Terminal

28 Negative Electrode Terminal

30 Exhaust Chamber

40a, 40b Deposition

50 Hole

1. A battery module comprising a plurality of battery blocks connected in series, wherein
each battery block includes a plurality of batteries connected in parallel,
each battery includes a release portion through which a gas generated in the battery is released,
each battery block further includes
a holder in which the batteries are housed with the release portions oriented in an identical direction,
a bus bar provided over the holder and connecting in parallel electrodes of the batteries located toward the release portions, and
a lid provided over the bus bar and defining between the bus bar and the lid an exhaust chamber through which the gas released from at least one of the release portions is released outside the battery block,
the lids of at least two of the battery blocks are physically connected to each other,
the lid of each battery block is made of aluminum or a material having an ionization tendency greater than that of aluminum, and
the bus bar is made of copper.

2. The battery module of claim 1, wherein
at least two of the battery blocks are arranged in parallel, and
the lids of the at least two battery blocks are formed as a common lid.

3. The battery module of claim 1, wherein
at least two of the battery blocks are stacked one above another, and
the lids of the at least two battery blocks are in contact with each other at faces of the lids opposite to the batteries of the corresponding battery block.
